(19) United States
(12) Patent Application Publication
(10) Pub. No.: US 2026/0189358 A1
(43) Pub. Date: Jul. 2, 2026

(54) MITIGATION FOR ASYMMETRIC RELAY ATTACKS IN TEMPORARY TOKENS

(71) Applicant: Google LLC, Mountain View, CA (US)

(72) Inventors: Robert J. Greenwalt, III, Woodside, CA (US); Amol Tuli, Dublin, CA (US); Roger Piqueras Jover, Brooklyn, NY (US)

(21) Appl. No.: 19/425,158

(22) Filed: Dec. 18, 2025

Related U.S. Application Data
(60) Provisional application No. 63/740,532, filed on Dec. 31, 2024.

(51) Int. Cl. H04L 9/00; H04L 9/32

(52) U.S. Cl. CPC H04L 9/002; H04L 9/3247

(57) ABSTRACT

Responsive to receiving a request to verify a temporary token, an example computing system for mitigating relay attacks may generate, using a trusted framework including an application programming interface, a cryptographically signed data bundle including a cryptographic signature for a calling application. The computing system may receive a request to verify a cryptographic signature for the cryptographically signed data bundle and the signature for the calling application. The computing system may determine, based on a public key for the application programming interface, whether the cryptographic signature for the cryptographically signed data bundle is verified, and determine, based on a signature for a trusted application, whether the signature for the calling application is verified. Responsive to determining the cryptographic signature for the cryptographically signed data bundle is verified and the signature for the calling application is verified, the computing system may verify the temporary token.

### CROSS REFERENCE TO RELATED APPLICATION

This application claims the benefit of U.S. Provisional Patent Application No. 63/740,532 filed December 31, 2024, which is incorporated by reference herein in its entirety.

### BACKGROUND

Remote attestation is a mechanism for authenticating and verifying the integrity of a computing device to determine whether the platform is trusted. In some examples, a computing system may perform remote attestation of a computing device via the use of hardware security assurances to determine whether the computing device has been modified or otherwise compromised. Such hardware security assurances may be provided using specialized hardware and/or firmware, such as a trusted platform module (TPM) chip or other physical security mechanisms, in the computing device that can prove the integrity of the computing device to the computing system.

### SUMMARY

In general, the techniques of this disclosure are directed to using asymmetric difficulty to prevent relay attacks. An example computing system including a trusted operating system (OS) may be in communication with a remote device (e.g., a user device), a local device (e.g., a bad actor device), and a cellular communications carrier. The user device may include a first application, e.g., a bad actor application, and may be in communication with the bad actor device. The trusted OS may include a trusted framework including a trusted application programming interface (API). In some examples, the bad actor device may include a second application, e.g., a trusted application. Responsive to sending a request to verify a temporary token (e.g., a token that can be used to gain access to a user account, such as the user’s bank account), the user device may receive, from the computing system including the trusted framework, a cryptographically signed data bundle including a signature for an application from which the request was initiated, i.e., a “calling” application. For example, the calling application may be the bad actor application installed on the user device. In an example relay attack, the bad actor application on the user device may forward the cryptographically signed data bundle to the bad actor device. In some examples, a hacked framework on the bad actor device may alter or manipulate the cryptographic signature for the cryptographically signed data bundle. As such, when the bad actor device sends a request to the computing system to verify the cryptographic signature for the cryptographically signed data bundle (e.g., to verify the temporary token that grants access to a user account for the trusted application), the computing system may determine, based on a public key for the trusted API, the cryptographic signature for the cryptographically signed data bundle is not verified. Additionally, or alternatively, the computing system may determine that the signature for the calling application is not verified. In some examples, responsive to determining that the cryptographically signed data bundle is valid and the digital signature for the calling application is valid, the computing system may verify the temporary token. As such, the temporary token may only be verified when the computing system determines that the cryptographically signed data bundle is valid and that the digital signature for the calling application is valid.

In one example, the techniques described herein are directed to a method that includes, responsive to receiving a request to verify a temporary token, generating, by a computing system and using a trusted framework including an application programming interface, a cryptographically signed data bundle including a signature for a first application. The method further includes receiving, by the computing system, a request to verify a cryptographic signature for the cryptographically signed data bundle and the signature for the first application. The method further includes determining, by the computing system, and based on a public key for the application programming interface, whether the cryptographic signature for the cryptographically signed data bundle is verified, and determining, by the computing system, and based on a signature for a second application, whether the signature for the first application is verified. The method further includes, responsive to determining the cryptographic signature for the cryptographically signed data bundle is verified and the signature for the first application is verified, verifying, by the computing system, the temporary token.

In another example, the techniques described herein are directed to a computing system that includes a memory that stores instructions, and one or more processors. The instructions, when executed by one or more processors, cause the one or more processors to, responsive to receiving a request to verify a temporary token, generate, using a trusted framework including an application programming interface, a cryptographically signed data bundle including a signature for a first application. The instructions further cause the one or more processors to receive a request to verify a cryptographic signature for the cryptographically signed data bundle and the signature for the first application. The instructions further cause the one or more processors to determine, based on a public key for the application programming interface, whether the cryptographic signature for the cryptographically signed data bundle is verified, and determine, based on a signature for a second application, whether the signature for the first application is verified. The instructions further cause the one or more processors to, responsive to determining the cryptographic signature for the cryptographically signed data bundle is verified and the signature for the first application is verified, verify the temporary token.

In another example, the techniques described herein are directed to a non-transitory computer-readable storage medium that includes instructions. The instructions, when executed by one or more processors, cause the one or more processors to, responsive to receiving a request to verify a temporary token, generate, using a trusted framework including an application programming interface, a cryptographically signed data bundle including a signature for a first application. The instructions further cause the one or more processors to receive a request to verify a cryptographic signature for the cryptographically signed data bundle and the signature for the first application. The instructions further cause the one or more processors to determine, based on a public key for the application programming interface, whether the cryptographic signature for the cryptographically signed data bundle is verified, and determine, based on a signature for a second application, whether the signature for the first application is verified. The instructions further cause the one or more processors to, responsive to determining the cryptographic signature for the cryptographically signed data bundle is verified and the signature for the first application is verified, verify the temporary token.

In another example, the techniques described herein are directed to a computer program product for performing remote attestation of computing devices, the computer program product comprising instructions. The instructions, when executed by one or more processors, cause the one or more processors to, responsive to receiving a request to verify a temporary token, generate, using a trusted framework including an application programming interface, a cryptographically signed data bundle including a signature for a first application. The instructions further cause the one or more processors to receive a request to verify a cryptographic signature for the cryptographically signed data bundle and the signature for the first application. The instructions further cause the one or more processors to determine, based on a public key for the application programming interface, whether the cryptographic signature for the cryptographically signed data bundle is verified, and determine, based on a signature for a second application, whether the signature for the first application is verified.

The instructions further cause the one or more processors to, responsive to determining the cryptographic signature for the cryptographically signed data bundle is verified and the signature for the first application is verified, verify the temporary token.

The details of one or more examples are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example distributed system for remote attestation, in accordance with one or more aspects of the present disclosure.

FIG. 2 is a block diagram illustrating further details of an example computing system, in accordance with one or more aspects of the present disclosure.

FIG. 3 is a block diagram illustrating further details of an example distributed system for remote attestation, in accordance with one or more aspects of the present disclosure.

FIG. 4 is a block diagram illustrating further details of an example distributed system for remote attestation, in accordance with one or more aspects of the present disclosure.

FIG. 5 is a block diagram illustrating further details of an example distributed system for remote attestation, in accordance with one or more aspects of the present disclosure.

FIG. 6 is a flow chart of an example process for remote attestation, in accordance with aspects of this disclosure.

### DETAILED DESCRIPTION

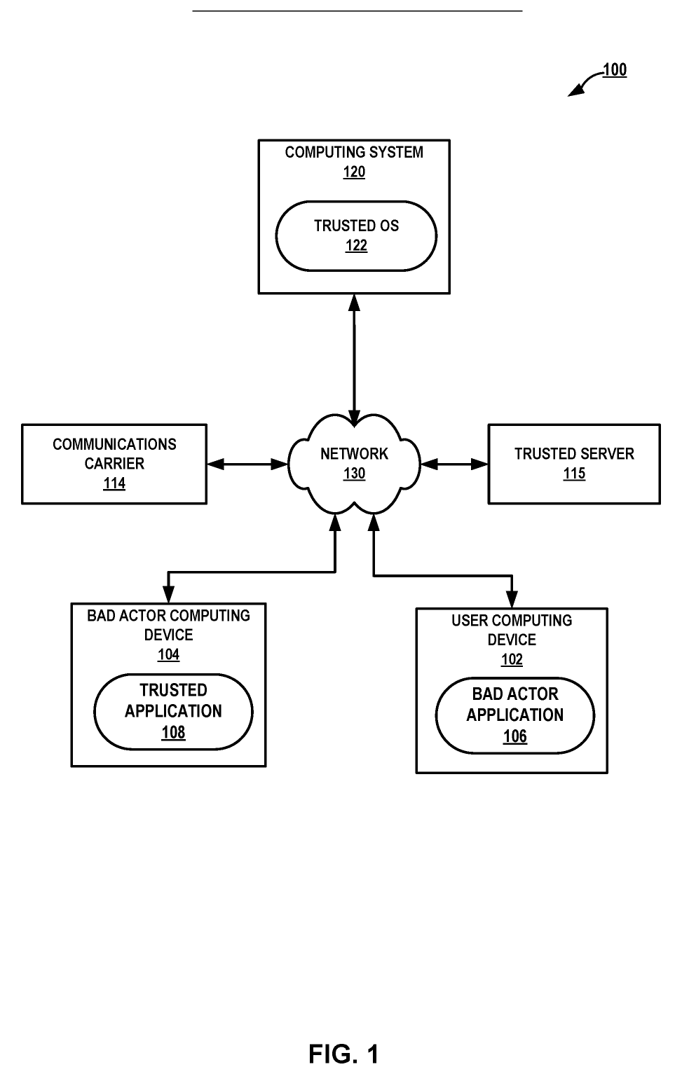

FIG. 1 is a conceptual diagram illustrating an example distributed system for remote attestation, in accordance with one or more aspects of the present disclosure. In the example of FIG. 1, distributed system 100 may include computing system 120 that communicates with user computing device 102, bad actor computing device 104, trusted server 115, and communications carrier 114 via network 130.

Computing system 120 may represent any suitable computing system, such as one or more desktop computers, laptop computers, mainframes, servers, cloud computing systems, etc. capable of sending and receiving information both to and from a network, such as network 130. In some examples, the components of computing system 120 illustrated in FIG. 1 may reside in and execute on the same or separate computing devices and systems operated by and/or under the control of one or more entities. For example, in some examples, the components of computing system 120 may reside in and execute on user computing device 102. As such, in some examples, the techniques described herein may be performed by user computing device 102, i.e., the techniques described herein may be implemented “on-device” by user computing device 102. In some examples, computing system 120 may represent one or more cloud computing systems that provide access to their respective services via a cloud.

Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between computing system 120, user computing device 102, bad actor computing device 104, trusted server 115, and communications carrier 114. Computing system 120, user computing device 102, bad actor computing device 104, trusted server 115, and communications carrier 114 may transmit and receive data across network 130 using any suitable communication techniques. Each of computing system 120, user computing device 102, bad actor computing device 104, trusted server 115, and communications carrier 114 may be operatively coupled to network 130 using respective network links, such as Ethernet, Wi-Fi, or any other types of wired and/or wireless network connections. In some examples, however, distributed system 100 may not include one or more components of FIG. 1, and/or one or more components of FIG. 1 may not communicate with one or more other components of FIG. 1 via network 130.

In general, user computing device 102 and/or bad actor computing device 104 may each represent an individual mobile or non-mobile computing device. Examples of user computing device 102 and/or bad actor computing device 104 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device. In some examples, user computing device 102 and/or bad actor computing device 104 may not include and/or use specialized hardware and/or firmware, such as a trusted platform module (TPM) chip or other physical security mechanisms, for proving the integrity of a respective computing device or for providing any hardware security assurances.

In general, bad actor application 106 may represent any suitable software application executing on user computing device 102 that behaves maliciously, either intentionally or as a result of being compromised. In general, bad actor application 106 may appear as legitimate, e.g., bad actor application 106 may appear on user computing device 102 as a trusted application. That is, bad actor application 106 may be a malicious imitation of trusted application 108, and may perform harmful actions to exploit vulnerabilities, steal sensitive user information, etc.

A user of user computing device 102 may interact with an interface (e.g., a graphical user interface) associated with bad actor application 106 to cause user computing device 102 to perform a function. A user of bad actor computing device 104 may interact with an interface (e.g., a graphical user interface) associated with trusted application 108 to cause bad actor computing device 104 to perform a function. Numerous examples of trusted application 108 may exist and include, for example, a banking application, a video streaming application, a calendar application, a personal assistant or prediction engine, a search application, a map or navigation application, a transportation service application (e.g., a bus or train tracking application), a social media application, a game application, an e-mail application, a messaging application, an Internet browser application, or any and all other applications that may execute at a computing device. Bad actor application 106 may be a malicious imitation of the aforementioned trusted application examples.

In general, trusted application 108 and/or bad actor application 106 may send requests to computing system 120, e.g., request to verify a temporary token, a request to verify a user account (such as to sign into a user’s account or recover a user’s account), etc. That is, computing system 120 may receive requests associated with multifactor authentication (MFA). An application from which a request is initiated may be referred to as a “calling” application. For example, in the example of FIG. 1, the calling application may be bad actor application 106 installed on user computing device 102. In some examples, user computing device 102 may be considered a victim device in a relay attack, and bad actor computing device 104 may be a perpetrator of the relay attack. A relay attack, or a Man-in-the-Middle (MIM) attack, is a type of cyberattack in which an attacker (e.g., bad actor computing device 104) may intercept and forward communications between two parties that may be unaware of the attacker’s presence. In the example of FIG. 1, bad actor computing device 104 may attempt to convince computing system 120 that computing device 120 is communicating with user computing device 102, while in reality, computing system 120 is communicating with bad actor computing device 104. If the attempt made by bad actor computing device 104 is successful, trusted application 108 may be tricked as well, and thus a bad actor operating bad actor computing device 104 may access a user's account in trusted application 108. To initiate the relay attack, a user operating user computing device 102 may be convinced to install bad actor application 106, which may be an application “masking” as trusted application 108, or some other legitimate application. In general, there may not be any relationship between bad actor application 106 and trusted application 108. In some examples, trusted application 108 may be an application that requires MFA prior to accepting a temporary token, e.g., to grant access to a user account. That is, to sign into a user’s account in trusted application 108, and/or to recover a user’s account in trusted application 108, trusted application 108 may require, for example, a correct username and password and a valid temporary token that is generated and sent to the computing device (e.g., mobile device) associated with the user’s account.

In a typical relay attack, a bad actor application may harvest the temporary tokens received by a user computing device, and then forward them to a bad actor computing device being operated by an attacker, such that the attacker may use the temporary tokens to gain access to the user’s account in the trusted application. As an example, in a typical relay attack, a user operating a user computing device, when attempting to sign into a bad actor application, may request a temporary token. The user computing device may negotiate with the user’s cellular communications carrier to retrieve a temporary token for verification. The temporary token may be returned to the bad actor application, which may then forward the temporary token to a bad actor computing device. The attacker operating the bad actor computing device may then use the temporary token to sign into the user’s account on a trusted application, or may use the temporary token to recover the user’s account on the trusted application. In this typical relay attack, the trusted application may not be able to ascertain that the temporary token was provided to the user computing, and not the bad actor computing device, and thus may grant the attacker access to the user’s account in the trusted application.

In the example of FIG. 1, computing system 120 may include a trusted operating system (OS) 122. That is, in general, trusted OS 122 may be considered an uncompromised OS including an uncompromised framework that may implement strong mechanisms for access control, use cryptographic methods for data integrity, perform authentication techniques, perform audits, track system activities, isolate processes and applications, comply with specified security standards, etc. In some examples, trusted OS 122 may be included in user computing device 102, and the techniques described herein may be implemented “on- device” by user computing device 102. Conversely, bad actor computing device 104 may include a compromised framework, and/or may not be able reproduce or forge data that is generated by computing system 120. As such, in the example of FIG. 1, an attempted relay attack may not require exploiting a zero-day vulnerability on user computing device 102, and instead may only require exploiting a zero-day vulnerability on bad actor computing device 104, which may cause the relay attack to be more feasible.

In general, computing system 120 may be able to perform full remote attestation of a computing device without computing system 120 and/or the computing device having and/or using specialized hardware and/or firmware, such as a trusted platform module (TPM) chip or other physical security mechanisms, to prove the integrity of the computing device. While specialized hardware and/or firmware may provide hardware security assurances that a computing device has not been modified or otherwise compromised, including such specialized hardware in computing devices may increase the manufacturing costs of these computing devices. Further, if the specialized hardware of a computing device is ever compromised, the computing device may permanently be prevented from providing hardware security assurances, which may prevent the computing device from performing certain functions that require such hardware security assurances.

Instead, in order for computing system 120 to verify that user computing device 102 and/or bad actor computing device 104 has one or more properties that are required in order for user computing device 102 and/or bad actor computing device 104 to perform a particular action, and to better prevent successful relay attacks, computing system 120 may generate a cryptographically signed data bundle when computing system 120 receives a request to perform the particular action. For example, in the example of FIG. 1, a user operating user computing device 102 may attempt to sign into bad actor application 106, in which bad actor application 106 may indicate multifactor authentication is required before the user can access their account. A request to verify a temporary token (e.g., a token that can be used to verify the user account) may be sent to computing system 120 from user computing device 102. Trusted OS 122, which may include a trusted framework including a trusted application programming interface (API), may generate a cryptographically signed data bundle including a signature for the calling application from which the request was initiated, e.g., bad actor application 106 installed on user computing device 102. As such, the cryptographically signed data bundle generated by computing system 120 may include a signature for bad actor application 106. The cryptographically signed data bundle generated by computing system 120 may further include the temporary token.

In some examples, the “cryptographically signed data bundle” may refer to a data package that is encrypted with a public key from a cryptographic public-private key pair and is decrypted with a private key from the cryptographic public-private key pair (e.g., the private key may be needed to access contents of the cryptographically signed data bundle). In general, though, the “cryptographically signed data bundle” may refer to a data package that is generated by trusted OS 122 and includes a signature that is created using a private key, e.g., a private key for a trusted API. A public key, e.g., a public key for the trusted API, may be shared across components of FIG. 1 and may be used to verify the signature of the cryptographically signed data bundle.

In general, the cryptographically signed data bundle may include the temporary token and the calling application digital signature. In some examples, the cryptographically signed data bundle may include a temporary token and a calling package signature, and the cryptographically signed data bundle may be signed. As such, in some examples, an application may verify the bundle signature and then verify whether its package signature is in the bundle. In this way, an application may determine whether the bundle (and temporary token) was created for itself.

In some examples, the temporary token may be obtained from communications carrier 114, which may be a cellular communications carrier or a mobile network operator (MNO). In some examples, the temporary token may be an operator-generated token that uses network data to authenticate the “source” computing device, i.e., the device from which the request was initiated.

In general, a “signature” for an application may be an application identifier (e.g., a unique identifier, an application name, or the like. In some examples, though, trusted OS 122 may identify a calling application and create a unique public-private key pair for the calling application, in which trusted OS 122 may then create a calling application digital signature using the private key from the unique public-private key pair. In some other examples, the signature for the calling application may be created by the calling application using its own private key.

In general, the request received by computing system 120 may include the calling application digital signature (which may be an identifier for the calling application), and computing system 120 may then “wrap” the calling application digital signature with the temporary token into the cryptographically signed data bundle. As such, in the example of FIG. 1, trusted OS 122 may return a cryptographically signed data bundle that includes a temporary token including a reference to user computing device 102 and a signature for bad actor application 106.

In the example of FIG. 1, in an attempted relay attack, when computing system 120 returns the cryptographically signed data bundle to user computing device 102, the cryptographically signed data bundle may be forwarded to bad actor computing device 104 (e.g., via bad actor application 106). Then, a user operating bad actor computing device 104 may attempt to gain access to trusted application 108 using the cryptographically signed data bundle. To do so, trusted application 108 may send a request to computing system 120 to determine whether the cryptographic signature for the cryptographically signed data bundle is verified. In some examples, such as in FIG. 1 where trusted application 108 is executing on bad actor computing device 104, the cryptographic signature for the cryptographically signed data bundle may be altered or manipulated by bad actor computing device 104, e.g., due to a hacked framework on bad actor computing device 104 that “breaks” the signature. As such, in these examples, computing system 120 may determine, based on the public key for the trusted API, that the cryptographic signature for the cryptographically signed data bundle is not verified (i.e., the public key for the trusted API may not verify the altered, manipulated, or broken signature).

In some other examples, verification may be performed “on-device.” That is, in some examples, trusted application 108 executing on bad actor computing device 104 may attempt to verify the cryptographic signature for the cryptographically signed data bundle with the hacked framework of bad actor computing device 104, in which verification may fail due to the signature being altered, manipulated, or broken by the hacked framework, and/or the hacked framework does not possess the capabilities for performing verification. Furthermore, the hacked framework may not be able to reproduce or forge the signature of the cryptographically signed data bundle data that is generated by trusted OS 122 and is expected by trusted application 108.

Additionally, or alternatively, trusted application 108 may send a request to computing system 120 to determine whether the signature for the calling application is verified. As shown in the example of FIG. 1, distributed system 100 includes trusted server 115. In general, trusted server 115 may be a trusted server for trusted application 108. For example, if trusted application 108 is a trusted banking application, trusted server 115 may be a trusted bank server. In some examples, trusted application 108 and trusted server 115 may be in secure communication, e.g., via Transport Layer Security (TLS) or Secure Sockets Layer (SSL) encryption. Thus, in some examples, trusted application 108 may send, e.g., via a TLS or SSL connection, a request to trusted server 115 to determine whether the signature for the calling application is verified. That is, in general, trusted application 108 may use computing system 120 and/or trusted server 115 to determine whether the signature for the calling application is the signature for trusted application 108. Thus, in these examples, bad actor computing device 104 may not be able to interfere with the verification of the signature for the calling application.

As such, trusted server 115 and/or computing system 120 in communication with trusted server 115 may determine, based on the signature for trusted application 108, whether the signature for the calling application is verified. In the example of FIG. 1, for instance, trusted server 115 and/or computing system 120 in communication with trusted server 115 may determine that the signature for trusted application 108 does not verify the signature for bad actor application 106, e.g., the signature for trusted application 108 may not match the signature for bad actor application 106. In some other examples, trusted server 115 and/or computing system 120 in communication with trusted server 115 may determine that the signature for trusted application 108 does not verify the signature that was created using a private key for bad actor application 106. In either case, the request to verify the temporary token and/or the user account may be denied.

In some examples, responsive to determining the cryptographic signature for the cryptographically signed data bundle is verified and the signature for the calling application is verified, computing system 120 may extract, from the cryptographically signed data bundle, the temporary token, which trusted application 108 may receive. However, as an additional verification step, computing system 120 may determine, based on the temporary token, whether the request to verify the signatures is associated with a trusted computing device. For example, the temporary token may include a reference to a “source” computing device including the calling application. In some examples, the temporary token may be an operator-generated token that uses network data to authenticate the source computing device. Computing system 120 may determine, using communications carrier 114 (which may be a cellular communications carrier), whether the request to verify the signatures is associated with the source computing device. That is, computing system 120 may determine, using communications carrier 114, whether the request to verify the signatures came from the same device that includes the calling application from which the temporary token verification request and/or the user account verification request originated. Responsive to communications carrier 114 determining that the request to verify the signatures is associated with the source computing device, computing system 120 may determine that the request to verify the signatures is associated with a trusted computing device, i.e., the source computing device and the trusted computing device are the same device. Then, computing system 120 may verify the temporary token for the calling application, e.g., the token may be used to gain access to the user account for the calling application.

As an example, in the example of FIG. 1, the temporary token may include a reference to user computing device 102, as user computing device 102 includes bad actor application 106 (which is the calling application in this example). However, computing system 120 may receive the request to verify the signatures from bad actor computing device 104 (as bad actor application 106 may forward the cryptographically signed data bundle to bad actor computing device 104 in an attempted relay attack). Computing system 120 may determine, using communications carrier 114, whether the request to verify the signatures is associated with a trusted computing device, e.g., whether bad actor computing device 104 is a trusted computing device. Specifically, in this example, computing system 120 may determine, using communications carrier 114, and based on the reference to user computing device 102, that the request to verify the signatures is not associated with user computing device 102. That is, communications carrier 114 may determine that the request to verify the signatures came from bad actor computing device 104, which is different from user computing device 102. Responsive to communications carrier 114 determining that the request to verify the signatures is not associated with the source computing device (e.g., user computing device 102 in this example), computing system 120 may determine that the request to verify the signatures is not associated with a trusted computing device, and computing system 120 may deny the request to verify the temporary token and/or the user account for trusted application 108.

In some examples, other cryptography methods may be used for verification processes. For example, the cryptographically signed data bundle may additionally or alternatively be verified using mathematical proofs, e.g., a zero-knowledge proof. A zero-knowledge proof is a cryptographic technique in which a prover (e.g., user computing device 102 and/or bad actor computing device 104) can prove to a verifier (e.g., computing system 120) that the prover possesses knowledge of a secret parameter, referred to as a witness, satisfying some relation, without revealing the witness or any additional information to the verifier or anyone else. In the example of proving that user computing device 102 is in a particular configuration, a zero-knowledge proof may prove that user computing device 102 is in a particular configuration without revealing the configuration of user computing device 102 or any other information regarding user computing device 102. That is, a zero-knowledge proof that proves user computing device 102 has one or more properties may not reveal any additional information regarding what other properties user computing device 102 may or may not have.

One example of a zero-knowledge proof is a zero-knowledge succinct non-interactive argument of knowledge (zk-SNARK) proof. A zk-SNARK proof is succinct by being very small in size, such that verification of a zk-SNARK proof can be performed relatively quickly. A zk-SNARK proof is also non-interactive, such that only one set of information may be sent to the verifier for verification without any interaction from the verifier (i.e., without sending messages back and forth to and from the verifier), thereby decreasing the amount of network traffic communicated between user computing device 102 and the verifier (e.g., computing system 120). A zk-SNARK proof may also assure semantic security against a prover within polynomial time constraints. An encryption scheme that encrypts the plaintext is provable to be semantically secure if an adversary that receives either one of two plaintexts, m₀ and m₁, cannot guess with better probability than ½ whether a given ciphertext is an encryption of the plaintext m₀ or an encryption of plaintext m₁. A zk-SNARK proof therefore assures semantic security such that an adversary cannot feasibly extract information from a zk-SNARK proof besides proof that user computing device 102 has the one or more properties. A zk-SNARK proof cannot be constructed without access to the witness, so that the witness is verified as being present at the time the proof is generated. User computing device 102 may construct a zk-SNARK proof using an identity, which may be a unique piece of information bound to user computing device 102, such as a password or other information that is known only to user computing device 102 and a witness, which is a secret parameter, such that the zk-SNARK proof mathematically proves user computing device 102 has knowledge of the witness.

In the example of proving that user computing device 102 has one or more properties that are required to perform an action, e.g., accessing the data bundle and/or initiating another operation, the witness may be a secret parameter, such as in the form of a hash, an alphanumeric string, or any other piece of data, that indicates user computing device 102 has the one or more properties required to perform the action, and user computing device 102 may generate a zk-SNARK proof that mathematically proves user computing device 102 is in possession of the witness without indicating, in the zk-SNARK proof, the witness itself. Computing system 120 may also be in possession of the witness. As such, computing system 120 may verify a zk-SNARK proof by determining whether the zk-SNARK proof actually proves that user computing device 102 is in possession of the witness.

As such, in these examples, after computing system 120 generates the cryptographically signed data bundle associated with a unique public-private key pair, computing system 120 may return the cryptographically signed data bundle to user computing device 102, which may or may not forward the cryptographically signed data bundle to bad actor computing device 104. User computing device 102 and/or bad actor computing device 104 may then generate a mathematical proof, e.g., a zero-knowledge proof, demonstrating that the respective computing device has access to the corresponding private key and/or possesses one or more required properties (e.g., is in a particular configuration or has the necessary credentials) to access the cryptographically signed data bundle. User computing device 102 and/or bad actor computing device 104 may send this proof to computing system 120, and upon receiving the mathematical proof, computing system 120 may determine whether the proof is verified, so as to confirm that user computing device 102 and/or bad actor computing device 104 possesses the required properties. If the proof is successfully verified, computing system 120 may grant the respective computing device permission to perform the requested action, such as accessing the data bundle and/or initiating another operation. In general, computing system 120 may verify a zero-knowledge proof generated by user computing device 102, but may not verify a zero-knowledge proof generated by bad actor computing device 104. That is, in general, bad actor computing device 104 may not possess the required properties to perform a requested action, such as accessing the data bundle and/or initiating another operation.

As such, the techniques described in this disclosure may provide solutions for preventing relay attacks, as a user account for a trusted application may only be verified and/or accessed when a cryptographic signature for a data bundle is verified, a signature for a calling application is verified, and a token indicates the request for verifying the signatures for the data bundle and the calling application is received from a trusted computing device. By relying on the asymmetric difficulty associated with the cryptographically signed data bundle that includes the token and the signature for the calling application, callers on a bad actor computing device will either receive a correctly signed data bundle that was generated for some other application (e.g., the bad actor application executing on the user computing device, and will thus be ignored), or will receive an incorrectly signed data bundle (e.g., a data bundle generated using an untrusted API included in an untrusted framework or a data bundle altered by the untrusted framework) that fails validation (and is thus ignored). As such, techniques described in this disclosure may foil attempted relay attacks.

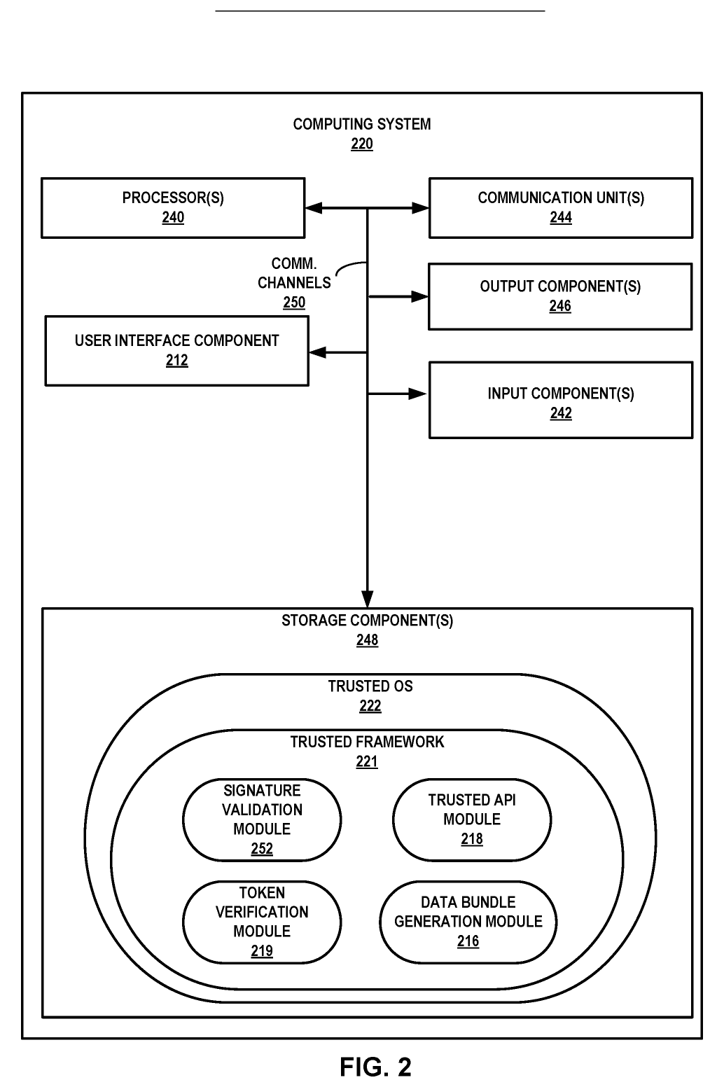

FIG. 2 is a block diagram illustrating further details of an example computing system, in accordance with one or more aspects of the present disclosure. Computing system 220 of FIG. 2 is described below as an example of computing system 120 as illustrated in FIG. 1.

Computing system 220 of FIG. 2 may be an example of any suitable computing system, such as one or more desktop computers, laptop computers, mainframes, servers, cloud computing systems, etc. capable of sending and receiving information both to and from a network. In some examples, computing system 220 may represent one or more cloud computing systems that provide access to their respective services via a cloud. In some examples, computing system 220 may be an example of a mobile phone, a tablet computer, a laptop computer, a desktop computer, a server, a mainframe, a set-top box, a television, a wearable device, a home automation device or system, a gaming system, a media player, an e-book reader, a mobile television platform, an automobile navigation or infotainment system, or any other type of mobile, non-mobile, wearable, and non-wearable computing device configured to receive, and output an indication of notification data. That is, in some examples, computing system 220 may be a user computing device (e.g., the components of computing system 220 may reside in and execute on user computing device 102 of FIG. 1).

FIG. 2 illustrates only one particular example of computing system 220, and many other examples of computing system 220 may be used in other instances and may include a subset of the components included in example computing system 220 or may include additional components not shown in FIG. 2. As shown in the example of FIG. 2, computing system 220 includes user interface components (UIC) 212, one or more processors 240, one or more input components 242, one or more communication units 244, one or more output components 246, and one or more storage components 248. One or more storage components 248 of computing system 220 also include trusted OS 222 (which may be similar if not substantially similar to trusted OS 122 of FIG. 1). Trusted OS 222, as shown, may further include trusted framework 221 including trusted API module 218, data bundle generation module 216, token verification module 219, and signature validation module 252.

Communication channels 250 may interconnect each of the components 240, 212, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing system 220 may receive input. Examples of input are tactile, audio, and video input. Input components 242 of computing system 220, in one example, includes a presence-sensitive display, touch-sensitive screen, mouse, keyboard, voice responsive system, video camera, microphone or any other type of device for detecting input from a human or machine.

One or more output components 246 of computing system 220 may generate output. Examples of output are tactile, audio, and video output. Output components 246 of computing system 220, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 244 of computing system 220 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 212 of computing system 220 may be hardware that functions as an input and/or output device for computing system 220. For example, UIC 212 may include a display component, which may be a screen at which information is displayed by UIC 212 and a presence-sensitive input component that may detect an object at and/or near the display component.

One or more processors 240 may implement functionality and/or execute instructions within computing system 220. For example, one or more processors 240 on computing system 220 may receive and execute instructions stored by one or more storage components 248 that execute the functionality of data bundle generation module 216, token verification module 219, signature validation module 252, and trusted API module 218. The instructions executed by one or more processors 240 may cause computing system 220 to store information within one or more storage components 248 during program execution. Examples of one or more processors 240 include application processors, display controllers, sensor hubs, and any other hardware configured to function as a processing unit. One or more processors 240 may execute instructions of data bundle generation module 216, token verification module 219, signature validation module 252, and trusted API module 218 to perform actions or functions. That is, data bundle generation module 216, token verification module 219, signature validation module 252, and trusted API module 218 may be operable by one or more processors 240 to perform various actions or functions of computing system 220.

One or more storage components 248 within computing system 220 may store information for processing during operation of computing system 220. That is, computing system 220 may store data accessed by data bundle generation module 216, token verification module 219, signature validation module 252, and trusted API module 218 during execution at computing system 220. In some examples, one or more storage component 248 is a temporary memory, meaning that a primary purpose of one or more storage component 248 is not long-term storage. One or more storage components 248 on computing system 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage components 248, in some examples, also include one or more computer-readable storage media. One or more storage components 248 may be configured to store larger amounts of information than volatile memory. One or more storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage components 248 may store program instructions and/or information (e.g., data) associated with data bundle generation module 216, token verification module 219, signature validation module 252, and trusted API module 218.

In general, computing system 220 may receive requests from computing devices to perform various actions, such as verifying tokens and/or user accounts. In some examples, a computing device from which a request was sent may be permitted to perform certain actions only if computing system 220 can verify that the computing device has certain properties, such as having a certain configuration of data, software, hardware, and/or combinations thereof. As such, computing system 220 may perform remote attestation of a computing device to determine whether the computing device has one or more properties that are required in order for the computing device to be permitted to perform an action, and computing system 220 may permit the computing device to perform the action only if computing system 220 can verify that the computing device has the one or more required properties. Examples of the specific properties of a computing device include the whether the version of firmware installed at the computing device is within a specified range of versions, whether the firmware was installed at the computing device at the factory or via a software update that has been modified and/or tampered, whether the computing device has been modified, whether the computing device is in a valid configuration, whether specific peripherals are connected and/or not connected to the computing device, whether the manufacturing date of the computing device is within a specified range of dates, and/or any combination thereof.

In general, trusted OS 222 includes trusted framework 221 including trusted API module 218. Trusted framework 221 may refer to a set of reusable libraries, tools, or protocols, and may be or include a web development framework, security framework, or network protocol. Trusted framework 221 may further include trusted API module 218, which may be or include one or more trusted APIs that may expose certain functionalities or services that trusted framework 221 provides, e.g., trusted API module 218 may include APIs for routing, database interaction, authentication, etc. In general, computing system 220 may receive a request from a calling application to verify a temporary token (e.g., for MFA). The request may include a digital signature for the calling application, e.g., an identifier for the calling application, and/or a cryptographic signature that was created using the calling application’s private key. Responsive to computing system 220 receiving the request to verify a temporary token, trusted API module 218 may generate a cryptographically signed data bundle including the signature for the calling application and the temporary token. Specifically, to get the temporary token, trusted API module 218 may use a secure protocol (e.g., HTTPS) to connect to a cellular communications carrier associated with the device from which the request was received, such as communications carrier 114 of FIG. 1. Trusted API module 218 may connect to the communications carrier’s authentication or identity verification servers after providing credentials, digital certificates, etc. that authenticate the API request. In some examples, trusted API module 218 may include details in its request for the token, such as the computing device's mobile network information (e.g., IMEI, SIM identifier, etc.), user authentication details, a description of the requested token's purpose (e.g., one-time authentication), etc. In some examples, the token may be an operator-generated token that uses network data to authenticate the source computing device (e.g., a TS.43 token). The communications carrier may verify the request and, if valid, generate the token, which may then be sent back to trusted API module 218 in a secure response.

In the example of FIG. 2, data bundle generation module 216 may generate the cryptographically signed data bundle including the temporary token received by API module 218 and the signature for the calling application. In some examples, data bundle generation module 216 may generate a unique public-private key pair for the data bundle, and may create a signature for the data bundle using the private key. In general, the private key used to create the signature for the cryptographically signed data bundle may only be known to trusted framework 221. In some examples, the signature for the cryptographically signed data bundle may be created using a private key for trusted API module 218. The public key for the cryptographically signed data bundle, e.g., the public key for trusted API module 218, may be publicly shared and used to verify the signature for the cryptographically signed data bundle.

Computing system 220 may send the cryptographically signed data bundle to a computing device from which the request to verify the temporary token originated (e.g., a computing device including the calling application). Then, computing system 220 may receive another request to verify the cryptographic signature for the cryptographically signed data bundle and the signature for the calling application. That is, when a computing device receives the cryptographically signed data bundle, an application executing on the device may attempt to use the cryptographically signed data bundle to verify a user account.

As such, trusted framework 221 may include signature validation module 252, which may determine, based on the public key for the cryptographically signed data bundle, e.g., the public key for API module 218, whether the cryptographic signature for the cryptographically signed data bundle is verified. Furthermore, in some examples, signature validation module 252 may determine, based on a signature for a trusted application, whether the signature for the calling application is verified. In some examples, signature validation module 252 may be in communication with a trusted server (e.g., trusted server 115 of FIG. 1), in which signature validation module 252 may send a request to the trusted server to determine whether the signature for the calling application is verified. In some other examples, however, a trusted application may determine whether the signature for the calling application is verified by securely communicating with the trusted server, e.g., via TLS or SSL encryption. In general, though, a signature for a trusted application may only verify a signature for a calling application when the signatures match. In some other examples, additionally or alternatively, a signature for a trusted application may verify a signature for a calling application when the signature for the calling application is created using the correct corresponding private key for the trusted application (i.e., the calling application is the trusted application).

Responsive to signature validation module 252 determining the cryptographic signature for the cryptographically signed data bundle is verified and the signature for the calling application is verified, computing system 220 may determine that the temporary token is verified, and the temporary token may be received by the trusted application. As an additional verification step, however, token verification module 219 may determine, based on the temporary token, whether the request to verify the signatures is associated with a trusted computing device. That is, responsive to signature validation module determining the cryptographic signature for the cryptographically signed data bundle is verified and the signature for the calling application is verified, token verification module 219 may extract, from the cryptographically signed data bundle, the temporary token. In some other examples, token verification module 219 may receive the temporary token from the trusted application. The temporary token may include a reference to a source computing device including the calling application, which may or may not be the device on which the trusted application is executing. Token verification module 219 may determine, using the same communications carrier that generated the token, whether the request to verify the signatures is associated with the source computing device. That is, token verification module 219 may determine, using the communications carrier, whether the request to verify the signatures came from the same computing device that includes the calling application from which the temporary token verification request and/or the user account verification request originated. In some examples, token verification module 219 may determine whether the request to verify the signatures is associated with the source computing device based on a pre-Network Address Translation (NAT) IP address for the source computing device, i.e., the IP address of the source computing device before NAT is applied to it. In some examples, token verification module 219 may verify the token with the communications carrier over a cellular link from the computing device, and the communications carrier may assert whether the token applies to the computing device from which the signature verification request originated.

As such, in general, responsive to determining that the request to verify the signatures is associated with the source computing device, token verification module 219 may determine that the request to verify the signatures is associated with a trusted computing device, i.e., the source computing device and the trusted computing device are the same device. Then, computing system 220 may verify the temporary token for the trusted application, and the temporary token may be used to gain access to the user account in the trusted application.

In this way, before a user can gain access to a user account in a trusted application, e.g., before successfully passing multifactor authentication, computing system 220 may perform a series of verification steps involving cryptographic techniques that make forging or reproduction of data difficult. That is, the trusted application may require the cryptographic signature for the cryptographically signed data bundle generated by trusted OS 222 to be verified, the signature for the calling application to be verified (i.e., match the signature for the trusted application), and the temporary token to be verified prior to granting access to a user account. Provided that only trusted OS 222 may have access to the private key that was used to create the signature for the cryptographically signed data bundle, that the calling application digital signature may be required to match the trusted application digital signature, and that the token may be required to indicate the source computing device is a trusted computing device, bad actors or hackers may find it more difficult to successfully carry out relay attacks.

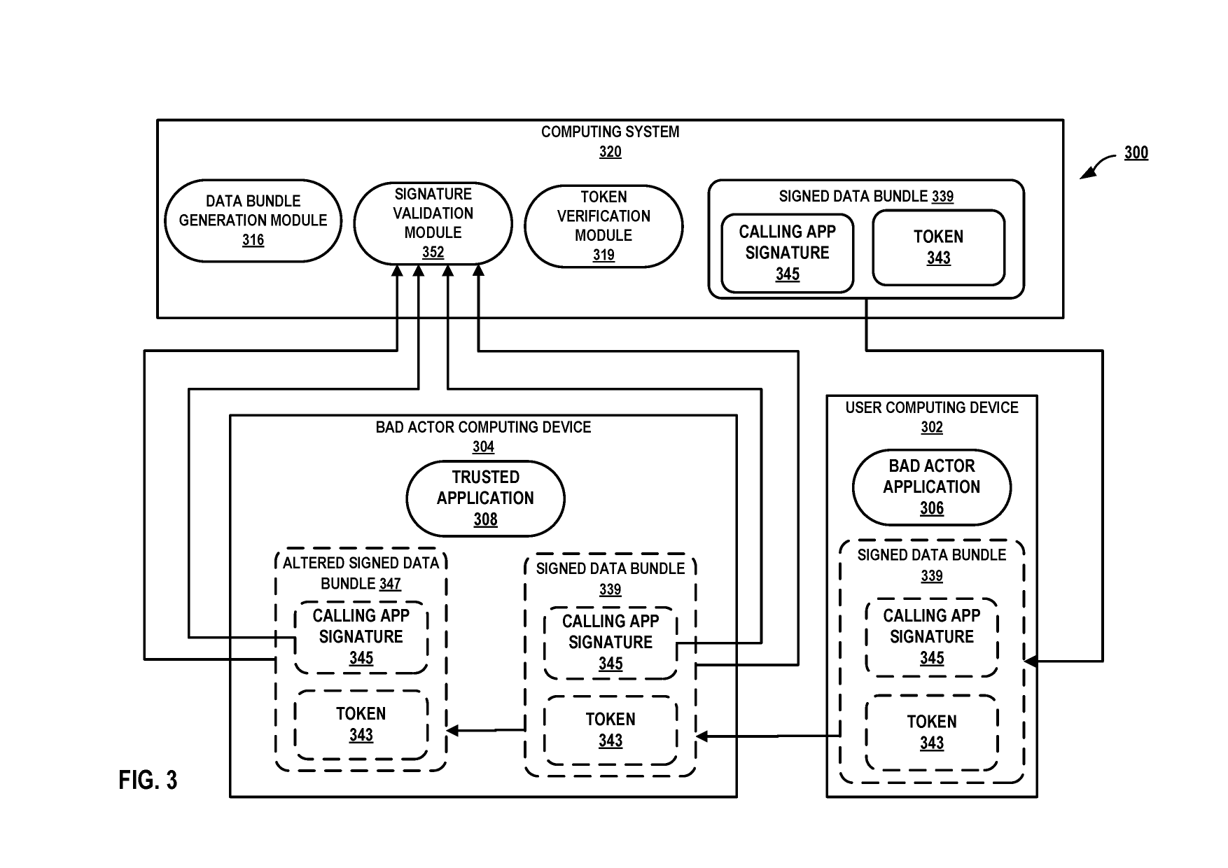

FIG. 3 is a block diagram illustrating further details of an example distributed system for remote attestation, in accordance with one or more aspects of the present disclosure. Distributed system 300, user computing device 302, bad actor application 306, bad actor computing device 304, and trusted application 308 of FIG. 3 may be similar if not substantially similar to distributed system 100, user computing device 102, bad actor application 106, bad actor computing device 104, and trusted application 108 of FIG. 1, respectively. Computing system 320, data bundle generation module 316, signature validation module 352, and token verification module 319 may be similar if not substantially similar to computing system 220, data bundle generation module 216, signature validation module 252, and token verification module 219 of FIG. 2, respectively.

In the example of FIG. 3, computing system 320 may receive, from bad actor application 306 executing on user computing device 302, a request to verify a temporary token. Responsive to receiving the request, data bundle generation module 316 may generate signed data bundle 339, which may be signed with a cryptographic signature created using a private key that only computing system 320 has access to. As shown in the example of FIG. 3, signed data bundle 339 may include calling app signature 345 and token 343. Specifically, in the example of FIG. 3, calling app signature 345 may be a digital signature for bad actor application 306. The digital signature for bad actor application 306 may be or include a unique identifier for bad actor application 306 (e.g., a name, number, or some other identifier for bad actor application 306). That is, the initial request to verify the temporary token that was sent from bad actor application 306 may include a signature for bad actor application 306, which data bundle generation module 316 may then include in signed data bundle 339. Token 343 may be retrieved by computing system 320 from a trusted communications carrier (e.g., communications carrier 114 of FIG. 1), and may include a reference to user computing device 302 (e.g., a pre-NAT IP address for user computing device 302. Computing system 320 may send, to user computing device 302, signed data bundle 339 including calling app signature 345 and token 343.

In an example relay attack, upon receiving signed data bundle 339, bad actor application 306 may forward signed data bundle 339 to bad actor computing device 304. That is, bad actor computing device 304 may attempt to use signed data bundle 339 to gain access to a user account in trusted application 308, e.g., by using token 343. In general, prior granting access to the user account (and/or accepting token 343), trusted application 308 may verify the cryptographic signature of signed data bundle 339 and calling app signature 345. In some examples, trusted application 308 may send a request to computing system 320 to determine whether the cryptographic signature for signed data bundle 339 is verified, e.g., signature validation module 352 may receive signed data bundle 339 and determine, based on the public key for the trusted API, whether the cryptographic signature for signed data bundle 339 is verified. In some examples, signature validation module 352 may receive signed data bundle 339 from bad actor computing device 304 and determine the cryptographic signature for signed data bundle 339 is verified. However, prior to verifying token 343 and/or the user account and granting token 343 for use, signature validation module 352 may further determine whether calling app signature 345 is verified. In some examples, signature validation module 352 may determine, based on a signature for trusted application 308, that calling app signature 345 is not verified, e.g., calling app signature 345 does not match the signature for trusted application 308. That is, signature validation module 352 may determine that calling app signature 345 does not correspond to trusted application 308, which, in the example of FIG. 3, is because calling app signature 345 instead corresponds to bad actor application 306. As such, signature validation module 352 may determine that calling app signature 345 is not verified and thus deny the request to verify the temporary token and/or the user account.

As shown in the example of FIG. 3, in some examples, the cryptographic signature for signed data bundle 339 may be altered or manipulated by bad actor computing device 304, e.g., due to a hacked framework on bad actor computing device 304 that “breaks” the signature. As such, in some examples, trusted application 308 may send a request to computing system 320 to determine whether the cryptographic signature for altered signed data bundle 347 is verified, e.g., signature validation module 352 may receive altered signed data bundle 347 and determine, based on the public key for the trusted API, whether the cryptographic signature for altered signed data bundle 347 is verified. In the example of FIG. 3, signature validation module 352 may determine that the public key for the trusted API does not verify the altered, manipulated, or broken signature for altered signed data bundle 347, and thus may deny the request to verify the temporary token and/or the user account.

As such, in general, responsive to computing system 220 determining the cryptographic signature for signed data bundle 339 is not verified, the cryptographic signature for altered signed data bundle 347 is not verified, or the signature for the calling application (e.g., bad actor application 306) is not verified, computing system 220 may deny the request to verify the temporary token and/or the user account. In some examples, denying the request to verify the temporary token and/or the user account may include invalidating token 343, e.g., token verification module 319 may determine that the token is invalid responsive to signature validation module 352 determining any of the signatures are not verified. In some examples, computing system 320 may send, to trusted application 308, an indication that the request to verify the temporary token and/or the user account has been denied, and thus trusted application 308 may not grant access to the user account. As such, the attempted relay attack in the example of FIG. 3 may be foiled.

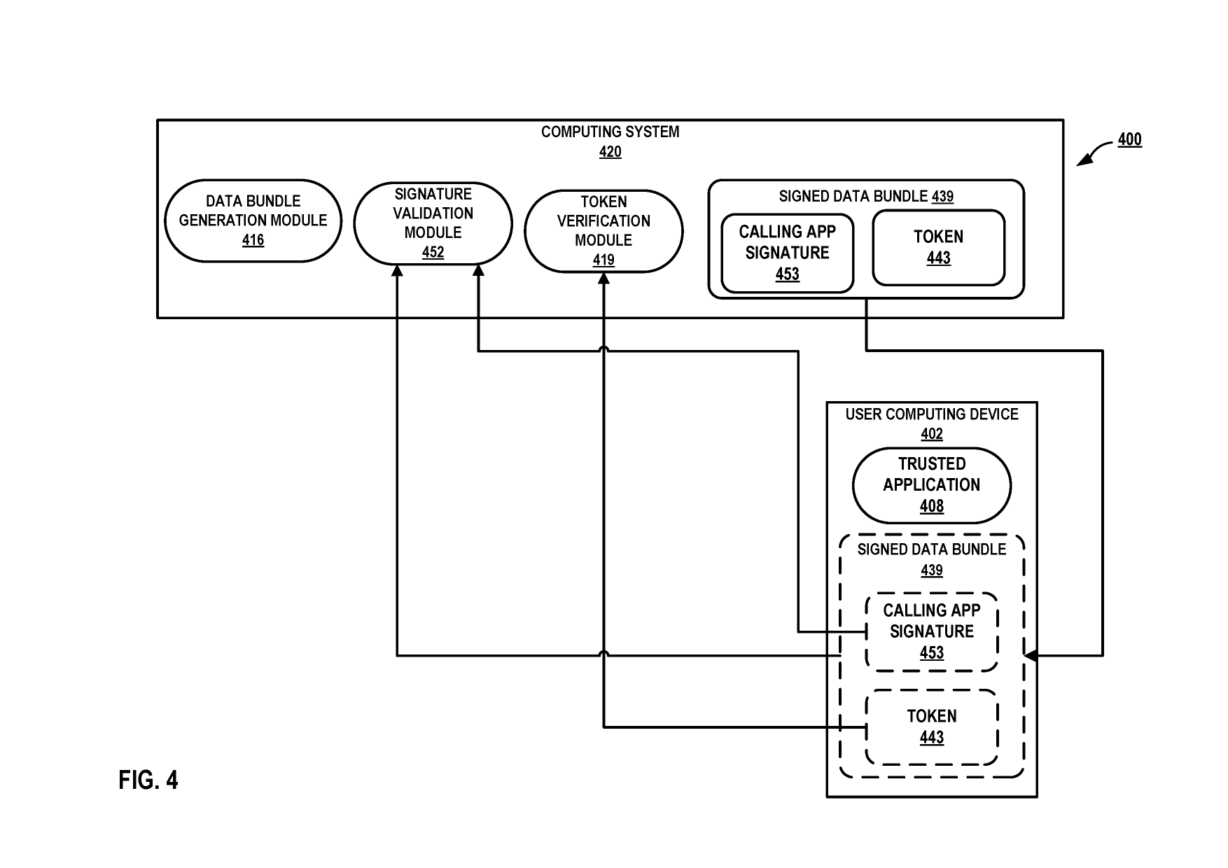

FIG. 4 is a block diagram illustrating further details of an example distributed system for remote attestation, in accordance with one or more aspects of the present disclosure. Distributed system 400, user computing device 402, and trusted application 408 of FIG. 4 may be similar if not substantially similar to distributed system 100, user computing device 102, and trusted application 108 of FIG. 1, respectively. Computing system 420, data bundle generation module 416, signature validation module 452, and token verification module 419 may be similar if not substantially similar to computing system 220, data bundle generation module 216, signature validation module 252, and token verification module 219 of FIG. 2, respectively.

In the example of FIG. 4, computing system 420 may receive, from trusted application 408 executing on user computing device 402, a request to verify a temporary token. Responsive to receiving the request, data bundle generation module 416 may generate signed data bundle 439, which may be signed with a cryptographic signature created using a private key that only computing system 420 has access to. As shown in the example of FIG. 4, signed data bundle 439 may include calling app signature 453 and token 443. Specifically, in the example of FIG. 4, calling app signature 453 may be a digital signature for trusted application 408. The digital signature for trusted application 408 may be or include a unique identifier for trusted application 408 (e.g., a name, number, or some other identifier for trusted application 408). That is, the initial request to verify the temporary token and/or the user account that was sent from trusted application 408 may include a signature for trusted application 408, which data bundle generation module 416 may then include in signed data bundle 439. Token 443 may be retrieved by computing system 420 from a trusted communications carrier (e.g., communications carrier 114 of FIG. 1), and may include a reference to user computing device 402 (e.g., a pre-NAT IP address for user computing device 402. Computing system 420 may send, to user computing device 402, signed data bundle 439 including calling app signature 453 and token 443.

The example of FIG. 4 may be an example in which a user operating a trusted computing device attempts to access their account in a trusted application. Still, prior granting access to the user account (and/or accepting token 443), trusted application 408 may verify the cryptographic signature of signed data bundle 439 and calling app signature 453. In the example of FIG. 4, signature validation module 452 may receive signed data bundle 439 and determine, based on the public key for the trusted API, that the cryptographic signature for signed data bundle 439 is verified. Signature validation module 452 may further determine that calling app signature 453 is verified. That is, in the example of FIG. 4, signature validation module 452 may determine, based on a signature for trusted application 408, that calling app signature 453 is verified, e.g., calling app signature 453 matches the signature for trusted application 408. In some other examples, signature validation module 452 may determine, based on a signature for trusted application 408, that calling app signature 453 is verified, e.g., a private key used to create calling app signature 453 does correspond to the signature for trusted application 408. In other words, signature validation module 452 may determine that calling app signature 453 does correspond to trusted application 408, because, in the example of FIG. 4, trusted application 408 is the calling application.

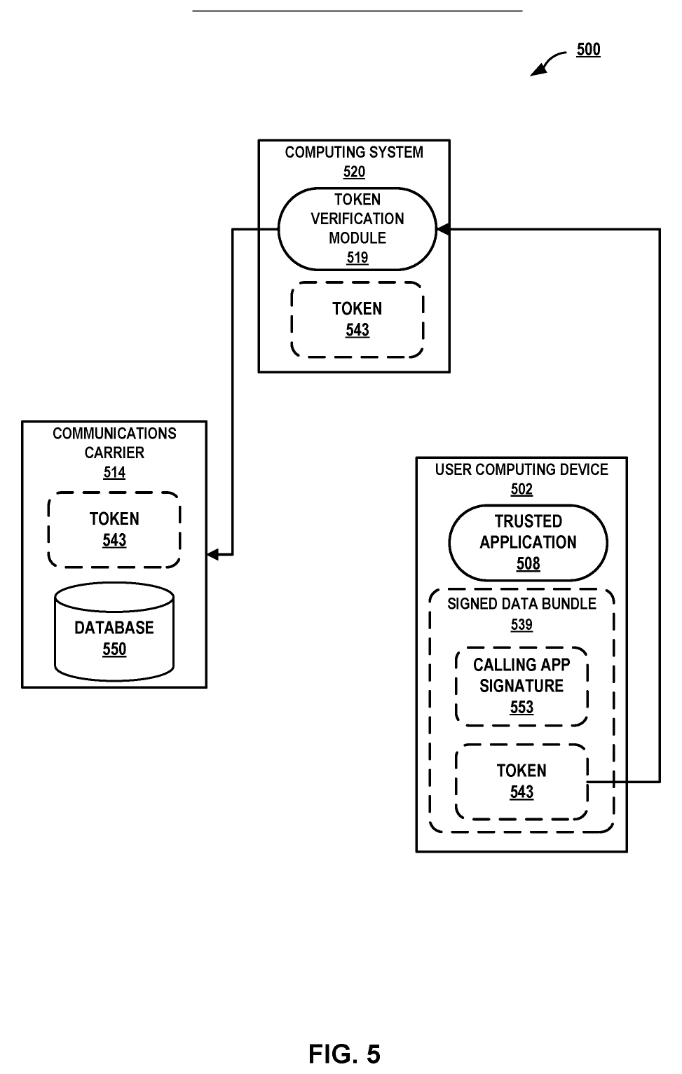

In some examples, responsive to computing system 420 determining the cryptographic signature for signed data bundle 439 is verified and calling app signature 453 is verified, computing system 420 may extract token 443 from signed data bundle 439 and further determine, using token verification module 419, whether token 443 indicates that the request to verify the cryptographic signature for signed data bundle 439 and calling app signature 453 is associated with a trusted computing device. In some examples, responsive to determining the cryptographic signature for signed data bundle 439 is verified and calling app signature 453 is verified, computing system 420 may receive token 443 from trusted application 408. In general, though, as described below in more detail with respect to FIG. 5, prior to token 443 being used to gain access to the user account in trusted application 408, token verification module 419 may first determine, using a communications carrier, whether token 443 is verified.

FIG. 5 is a block diagram illustrating further details of an example distributed system for remote attestation, in accordance with one or more aspects of the present disclosure. Distributed system 500, user computing device 502, trusted application 508, and communications carrier 514 of FIG. 5 may be similar if not substantially similar to distributed system 100, user computing device 102, trusted application 108, and communications carrier 114 of FIG. 1, respectively. Computing system 520 and token verification module 519 may be similar if not substantially similar to computing system 220 and token verification module 219 of FIG. 2, respectively.

In general, token 543 may be retrieved from communications carrier 514 by computing system 520 using a secure API protocol. That is, computing system 520 may connect to the communications carrier 514’s authentication or identity verification servers after providing credentials, digital certificates, etc. that authenticate the API request. In some examples, computing system 520 may include details in its request for token 543, such as mobile network information (e.g., IMEI, SIM identifier, etc.) for user computing device 502, user authentication details, a description of token 543's purpose (e.g., one-time authentication), etc. In some examples, token 543 may be an operator-generated token. In some examples, token 543 may be an operator-generated token that uses network data to authenticate the source computing device (e.g., a TS.43 token). As shown in the example of FIG. 5, in some examples, communications carrier 514 may include database 550, which may store information pertaining to computing devices that operate with communications carrier 514. As such, communications carrier 514 may use database 550 to verify the request and, if valid, generate token 543, which may then be sent back to computing system 520 in a secure response.

In general, token 543 may be or include a reference to a source computing device including the calling application for which signed data bundle 539 was initially generated. For example, token 543 may be or include an integer or a hash used to lookup an entry in a database that identifies the source computing device (e.g., a subscription identifier or other carrier-specific identifier). In some examples, token 543 may be or include a pre-NAT IP address for the source computing device. In the example of FIG. 5, token 543 may be or include a reference to user computing device 502, as user computing device 502 includes trusted application 508, which in this example, is the calling application. Computing system 520 may include token 543 in signed data bundle 539, which may be sent back to trusted application 508 executing on user computing device 502.

In the example of FIG. 5, prior to granting a user operating user computing device 502 access to trusted application 508, trusted application 508 may request computing system 520 to verify the signatures. Responsive to computing system 520 determining the cryptographic signature for signed data bundle 539 is verified and calling app signature 553 is verified, computing system 520 may verify token 543 (e.g., token 543 may be used to gain access to trusted application 508. In some examples, computing system 520 may extract token 543 from signed data bundle 539 (or may receive token 543 from trusted application 508) and further determine, using token verification module 519, whether token 543 indicates that user computing device 502 is a trusted computing device. For example, computing system 520 may use a cellular communications carrier to determine whether a trusted computing device is associated with the calling application.

For example, in some examples, token verification module 519 may determine, using communications carrier 514 that generated token 543, whether the request to verify the signatures is associated with the source computing device, i.e., the computing device that includes the calling application from which the the temporary token verification request and/or user account verification request originated. In some examples, token verification module 519 may verify token 543 with communications carrier 514 over a cellular link from user computing device 502, and communications carrier 514 may assert whether token 543 applies to the computing device from which the signature verification request originated.

In the example of FIG. 5, token verification module 519 may determine, using communications carrier 514, and based on the reference to user computing device 502 included in token 543, that the request to verify the cryptographic signature for signed data bundle 539 and calling app signature 553 is associated with user computing device 502. Responsive to determining that the request to verify the signatures is associated with user computing device 502, token verification module 519 may determine, using communications carrier 514, that user computing device 502 is a trusted computing device. Then, responsive to determining that user computing device 502 is a trusted computing device, computing system 520 may verify the temporary token for trusted application 508, and token 543 may be used to gain access to the user account for trusted application 508.

As such, the techniques described herein may provide solutions for preventing relay attacks, such as asymmetric relay attacks across remote devices. That is, the techniques described herein may exploit the asymmetric nature of these relay attacks and use it to prevent bad actors from successfully harvesting and using temporary tokens for MFA.

By relying on the asymmetric difficulty associated with the cryptographically signed bundle, callers on the bad actor device will either receive a correctly signed bundle that was generated for some other application (e.g., the bad actor application, and will thus be ignored), or will receive an incorrectly signed bundle (e.g., a bundle generated using an API included in the untrusted framework or a bundle altered by the untrusted framework) that fails validation (and is thus ignored). As such, the attempted relay attack may be foiled. In this way, MFA may be carried out in a more secure manner, as the use of signatures may maintain the trust of remote devices.

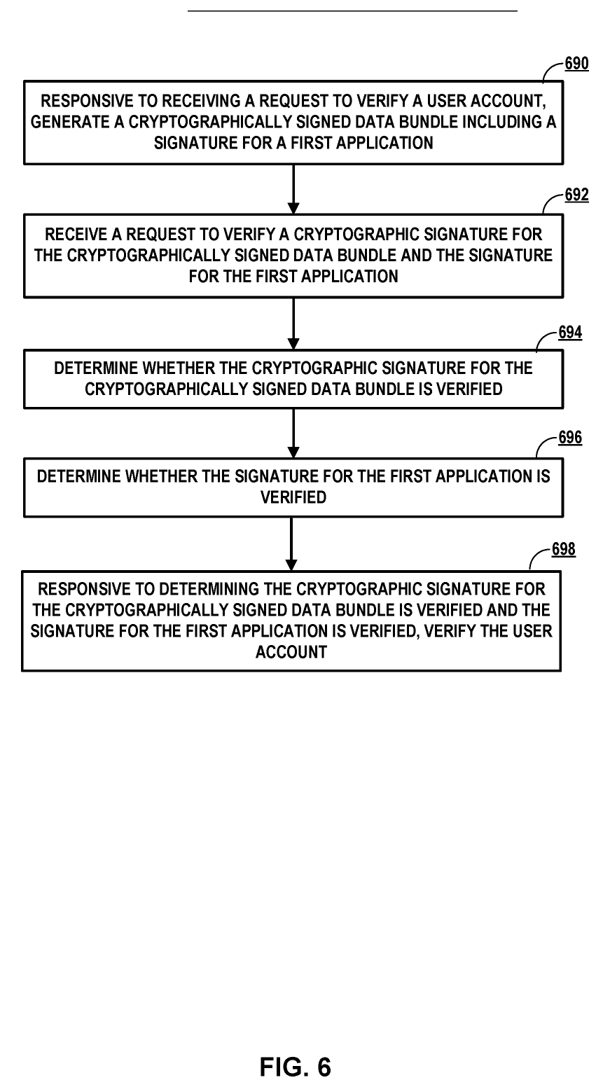

FIG. 6 is a flow chart of an example process for remote attestation, in accordance with aspects of this disclosure. For clarity, FIG. 6 may be described with respect to FIGS. 1-5.

Responsive to receiving a request to verify a temporary token, computing system 220 generates, using trusted framework 221 including trusted API module 218, signed data bundle 339 including a signature for a calling application (690). For example, signed data bundle 339 may include calling app signature 345 for bad actor application 306 or calling app signature 453 for trusted application 408. In some examples, bad actor application 306 may be executing at user computing device 102, which includes a trusted operating system, and trusted application 408 may be executing at bad actor computing device 104, which may include an untrusted operating system. Computing system 220 receives a request to verify a cryptographic signature for signed data bundle 339 and the signature for the calling application (692). For example, computing system 220 may receive a request to verify a cryptographic signature for signed data bundle 339 and calling app signature 345, or a request to verify a cryptographic signature for signed data bundle 339 and calling app signature 453. In some examples, computing system 220 may receive a request to verify a cryptographic signature for altered signed data bundle 347.

Signature validation module 352 determines, based on a public key for trusted API module 218, whether the cryptographic signature for the cryptographically signed data bundle is verified (694). For example, signature validation module 352 determines, based on a public key for trusted API module 218, that the cryptographic signature for signed data bundle 339 is verified, and that the cryptographic signature for altered signed data bundle 347 is not verified. Signature validation module 352 determines, based on a signature for trusted application 308, whether the signature for the calling application is verified (696). For example, signature validation module 352 determines, based on a signature for trusted application 308, that calling app signature 345 for bad actor application 306 is not verified, and that calling app signature 453 for trusted application 408 is verified.

Responsive to determining the cryptographic signature for the cryptographically signed data bundle is verified and the signature for the calling application is verified, computing system 220 verifies the temporary token (698). For example, responsive to determining the cryptographic signature for signed data bundle 339 is verified and calling app signature 453 for trusted application 408 is verified, computing system 220 verifies the temporary token.

Aspects of this disclosure include the following examples.

Example 1: A method includes responsive to receiving a request to verify a temporary token, generating, by a computing system and using a trusted framework including an application programming interface, a cryptographically signed data bundle including a signature for a first application; receiving, by the computing system, a request to verify a cryptographic signature for the cryptographically signed data bundle and the signature for the first application; determining, by the computing system, and based on a public key for the application programming interface, whether the cryptographic signature for the cryptographically signed data bundle is verified; determining, by the computing system, and based on a signature for a second application, whether the signature for the first application is verified; and responsive to determining the cryptographic signature for the cryptographically signed data bundle is verified and the signature for the first application is verified, verifying, by the computing system, the temporary token.

Example 2: The method of example 1, the method further including: responsive to determining that the cryptographic signature for the cryptographically signed data bundle is not verified or the signature for the first application is not verified, denying, by the computing system, the request to verify the temporary token.

Example 3: The method of any of examples 1 and 2, wherein the first application is executing at a first computing device including a trusted operating system, wherein the second application is executing at a second computing device including an untrusted operating system, and wherein the second application is a trusted application.

Example 4: The method of example 3, wherein the computing system receives the request to verify the cryptographic signature for the cryptographically signed data bundle and the signature for the first application from the second computing device, the method further includes determining, by the computing system, and based on the public key for the application programming interface, the cryptographic signature for the cryptographically signed data bundle is not verified; and responsive to determining the cryptographic signature for the cryptographically signed data bundle is not verified, denying, by the computing system, the request to verify the temporary token.

Example 5: The method of any of examples 3 and 4, wherein the computing system receives the request to verify the cryptographic signature for the cryptographically signed data bundle and the signature for the first application from the second computing device, the method further includes determining, by the computing system, and based on the signature for the second application, the signature for the first application is not verified; and responsive to determining the signature for the first application is not verified, denying, by the computing system, the request to verify the temporary token.

Example 6: The method of any of examples 1 through 5, wherein the cryptographically signed data bundle further includes the temporary token, and wherein verifying the temporary token further comprises: responsive to determining the cryptographic signature for the cryptographically signed data bundle is verified and the signature for the first application is verified, extracting, by the computing system and from the cryptographically signed data bundle, the temporary token; determining, by the computing system, and based on the temporary token, whether the request to verify the cryptographic signature for the cryptographically signed data bundle and the signature for the first application is associated with a trusted computing device; and responsive to determining that the request to verify the cryptographic signature for the cryptographically signed data bundle and the signature for the first application is associated with a trusted computing device, verifying, by the computing system, the temporary token.

Example 7: The method of example 6, further includes responsive to verifying the temporary token, verifying, by the computing system, a user account.

Example 8: The method of any of examples 6 and 7, wherein the temporary token includes a reference to a source computing device including the first application, and wherein determining whether the request to verify the cryptographic signature for the cryptographically signed data bundle and the signature for the first application is associated with the trusted computing device further comprises: determining, by the computing system and using a cellular communications carrier, and based on the reference, whether the request to verify the cryptographic signature for the cryptographically signed data bundle and the signature for the first application is associated with the source computing device; and responsive to determining that the request to verify the cryptographic signature for the cryptographically signed data bundle and the signature for the first application is associated with the source computing device, determining, by the computing system and using the cellular communications carrier, that the request to verify the cryptographic signature for the cryptographically signed data bundle and the signature for the first application is associated with the trusted computing device.

Example 9: The method of example 8, wherein the temporary token is an operator-generated token .

Example 10: A computing system includes a memory that stores instructions; and one or more processors that execute the instructions to: responsive to receiving a request to verify a temporary token, generate, using a trusted framework including an application programming interface, a cryptographically signed data bundle including a signature for a first application; receive a request to verify a cryptographic signature for the cryptographically signed data bundle and the signature for the first application; determine, based on a public key for the application programming interface, whether the cryptographic signature for the cryptographically signed data bundle is verified; determine, based on a signature for a second application, whether the signature for the first application is verified; and responsive to determining the cryptographic signature for the cryptographically signed data bundle is verified and the signature for the first application is verified, verify the temporary token.

Example 11: The computing system of example 10, wherein the one or more processors further execute the instructions to: responsive to determining that the cryptographic signature for the cryptographically signed data bundle is not verified or the signature for the first application is not verified, deny the request to verify the temporary token.

Example 12: The computing system of any of examples 10 and 11, wherein the first application is executing at a first computing device including a trusted operating system, wherein the second application is executing at a second computing device including an untrusted operating system, and wherein the second application is a trusted application.

Example 13: The computing system of example 12, wherein the one or more processors receive the request to verify the cryptographic signature for the cryptographically signed data bundle and the signature for the first application from the second computing device, wherein the one or more processors further execute the instructions to: determine, based on the public key for the application programming interface, the cryptographic signature for the cryptographically signed data bundle is not verified; and responsive to determining the cryptographic signature for the cryptographically signed data bundle is not verified, deny the request to verify the temporary token.

Example 14: The computing system of any of examples 12 and 13, wherein the one or more processors receive the request to verify the cryptographic signature for the cryptographically signed data bundle and the signature for the first application from the second computing device, wherein the one or more processors further execute the instructions to: determine, based on the signature for the second application, the signature for the first application is not verified; and responsive to determining the signature for the first application is not verified, deny the request to verify the temporary token.

Example 15: The computing system of any of examples 10 through 14, wherein the cryptographically signed data bundle further includes the temporary token, and wherein to verify the temporary token, the one or more processors further execute the instructions to: responsive to determining the cryptographic signature for the cryptographically signed data bundle is verified and the signature for the first application is verified, extract, from the cryptographically signed data bundle, the temporary token; determine, based on the temporary token, whether the request to verify the cryptographic signature for the cryptographically signed data bundle and the signature for the first application is associated with a trusted computing device; and responsive to determining that the request to verify the cryptographic signature for the cryptographically signed data bundle and the signature for the first application is associated with a trusted computing device, verify the temporary token.

Example 16: The computing system of example 15, wherein the one or more processors further execute the instructions to: responsive to verifying the temporary token, verify a user account.

Example 17: The computing system of any of examples 15 and 16, wherein the temporary token includes a reference to a source computing device including the first application, and wherein to determine whether the request to verify the cryptographic signature for the cryptographically signed data bundle and the signature for the first application is associated with the trusted computing device, the one or more processors further execute the instructions to: determine, using a cellular communications carrier, and based on the reference, whether the request to verify the cryptographic signature for the cryptographically signed data bundle and the signature for the first application is associated with the source computing device; and responsive to determining that the request to verify the cryptographic signature for the cryptographically signed data bundle and the signature for the first application is associated with the source computing device, determine, using the cellular communications carrier, that the request to verify the cryptographic signature for the cryptographically signed data bundle and the signature for the first application is associated with the trusted computing device.

Example 18: The computing system of any of examples 15 through 17, wherein the temporary token is an operator-generated token .

Example 19: A non-transitory computer-readable storage medium includes responsive to receiving a request to verify a temporary token, generate, using a trusted framework including an application programming interface, a cryptographically signed data bundle including a signature for a first application; receive a request to verify a cryptographic signature for the cryptographically signed data bundle and the signature for the first application; determine, based on a public key for the application programming interface, whether the cryptographic signature for the cryptographically signed data bundle is verified; determine, based on a signature for a second application, whether the signature for the first application is verified; and responsive to determining the cryptographic signature for the cryptographically signed data bundle is verified and the signature for the first application is verified, verify the temporary token.

Example 20: The non-transitory computer-readable storage medium of example 19, wherein the one or more processors further execute the instructions to: responsive to determining that the cryptographic signature for the cryptographically signed data bundle is not verified or the signature for the first application is not verified, deny the request to verify the temporary token.

Example 21: The non-transitory computer-readable storage medium of any of examples 19 and 20, wherein the first application is executing at a first computing device including a trusted operating system, wherein the second application is executing at a second computing device including an untrusted operating system, and wherein the second application is a trusted application.

Example 22: The non-transitory computer-readable storage medium of example 21, wherein the one or more processors receive the request to verify the cryptographic signature for the cryptographically signed data bundle and the signature for the first application from the second computing device, wherein the one or more processors further execute the instructions to: determine, based on the public key for the application programming interface, the cryptographic signature for the cryptographically signed data bundle is not verified; and responsive to determining the cryptographic signature for the cryptographically signed data bundle is not verified, deny the request to verify the temporary token.

Example 23: The non-transitory computer-readable storage medium of any of examples 21 and 22, wherein the one or more processors receive the request to verify the cryptographic signature for the cryptographically signed data bundle and the signature for the first application from the second computing device, wherein the one or more processors further execute the instructions to: determine, based on the signature for the second application, the signature for the first application is not verified; and responsive to determining the signature for the first application is not verified, deny the request to verify the temporary token.

Example 24: The non-transitory computer-readable storage medium of any of examples 19 through 23, wherein the cryptographically signed data bundle further includes the temporary token, and wherein to verify the temporary token, the one or more processors further execute the instructions to: responsive to determining the cryptographic signature for the cryptographically signed data bundle is verified and the signature for the first application is verified, extract, from the cryptographically signed data bundle, the temporary token; determine, based on the temporary token, whether the request to verify the cryptographic signature for the cryptographically signed data bundle and the signature for the first application is associated with a trusted computing device; and responsive to determining that the request to verify the cryptographic signature for the cryptographically signed data bundle and the signature for the first application is associated with a trusted computing device, verify the temporary token.

Example 25: The non-transitory computer-readable storage medium of example 24, wherein the one or more processors further execute the instructions to: responsive to verifying the temporary token, verify a user account.

Example 26: The non-transitory computer-readable storage medium of any of examples 24 and 25, wherein the temporary token includes a reference to a source computing device including the first application, and wherein to determine whether the request to verify the cryptographic signature for the cryptographically signed data bundle and the signature for the first application is associated with the trusted computing device, the one or more processors further execute the instructions to: determine, using a cellular communications carrier, and based on the reference, whether the request to verify the cryptographic signature for the cryptographically signed data bundle and the signature for the first application is associated with the source computing device; and responsive to determining that the request to verify the cryptographic signature for the cryptographically signed data bundle and the signature for the first application is associated with the source computing device, determine, using the cellular communications carrier, that the request to verify the cryptographic signature for the cryptographically signed data bundle and the signature for the first application is associated with the trusted computing device.

Example 27: The non-transitory computer-readable storage medium of example 26, wherein the temporary token is an operator-generated token .

Example 28: A computer program product for performing remote attestation of computing devices, the computer program product comprising instructions that, when executed by one or more processors, cause the one or more processors to: responsive to receiving a request to verify a temporary token, generate, using a trusted framework including an application programming interface, a cryptographically signed data bundle including a signature for a first application; receive a request to verify a cryptographic signature for the cryptographically signed data bundle and the signature for the first application; determine, based on a public key for the application programming interface, whether the cryptographic signature for the cryptographically signed data bundle is verified; determine, based on a signature for a second application, whether the signature for the first application is verified; and responsive to determining the cryptographic signature for the cryptographically signed data bundle is verified and the signature for the first application is verified, verify the temporary token.

Example 29. A computing device comprising: a memory that stores instructions; and one or more processors that execute the instructions to perform the method of any of examples 1-9.

Example 30. An apparatus comprising: means for performing the method of any of examples 1-9.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
responsive to receiving a request to verify a temporary token, generating, by a computing system and using a trusted framework including an application programming interface, a cryptographically signed data bundle including a signature for a first application;
receiving, by the computing system, a request to verify a cryptographic signature for the cryptographically signed data bundle and the signature for the first application;
determining, by the computing system, and based on a public key for the application programming interface, whether the cryptographic signature for the cryptographically signed data bundle is verified;
determining, by the computing system, and based on a signature for a second application, whether the signature for the first application is verified; and
responsive to determining the cryptographic signature for the cryptographically signed data bundle is verified and the signature for the first application is verified, verifying, by the computing system, the temporary token.

2. The method of claim 1, further comprising:
responsive to determining that the cryptographic signature for the cryptographically signed data bundle is not verified or the signature for the first application is not verified, denying, by the computing system, the request to verify the temporary token.

3. The method of claim 1, wherein the first application is executing at a first computing device including a trusted operating system, wherein the second application is executing at a second computing device including an untrusted operating system, and wherein the second application is a trusted application.

4. The method of claim 3, wherein the computing system receives the request to verify the cryptographic signature for the cryptographically signed data bundle and the signature for the first application from the second computing device, the method further comprising:
determining, by the computing system, and based on the public key for the application programming interface, the cryptographic signature for the cryptographically signed data bundle is not verified; and
responsive to determining the cryptographic signature for the cryptographically signed data bundle is not verified, denying, by the computing system, the request to verify the temporary token.

5. The method of claim 3, wherein the computing system receives the request to verify the cryptographic signature for the cryptographically signed data bundle and the signature for the first application from the second computing device, the method further comprising:
determining, by the computing system, and based on the signature for the second application, the signature for the first application is not verified; and
responsive to determining the signature for the first application is not verified, denying, by the computing system, the request to verify the temporary token.

6. The method of claim 1, wherein the cryptographically signed data bundle further includes the temporary token, and wherein verifying the temporary token further comprises:
responsive to determining the cryptographic signature for the cryptographically signed data bundle is verified and the signature for the first application is verified, extracting, by the computing system and from the cryptographically signed data bundle, the temporary token;
determining, by the computing system, and based on the temporary token, whether the request to verify the cryptographic signature for the cryptographically signed data bundle and the signature for the first application is associated with a trusted computing device; and
responsive to determining that the request to verify the cryptographic signature for the cryptographically signed data bundle and the signature for the first application is associated with a trusted computing device, verifying, by the computing system, the temporary token.

7. The method of claim 6, further comprising:
responsive to verifying the temporary token, verifying, by the computing system, a user account.

8. The method of claim 6, wherein the temporary token includes a reference to a source computing device including the first application, and wherein determining whether the request to verify the cryptographic signature for the cryptographically signed data bundle and the signature for the first application is associated with the trusted computing device further comprises:
determining, by the computing system and using a cellular communications carrier, and based on the reference, whether the request to verify the cryptographic signature for the cryptographically signed data bundle and the signature for the first application is associated with the source computing device; and
responsive to determining that the request to verify the cryptographic signature for the cryptographically signed data bundle and the signature for the first application is associated with the source computing device, determining, by the computing system and using the cellular communications carrier, that the request to verify the cryptographic signature for the cryptographically signed data bundle and the signature for the first application is associated with the trusted computing device.

9. The method of claim 8, wherein the temporary token is an operator-generated token.

10. A computing system comprising:
a memory that stores instructions; and
one or more processors that execute the instructions to:
responsive to receiving a request to verify a temporary token, generate, using a trusted framework including an application programming interface, a cryptographically signed data bundle including a signature for a first application;
receive a request to verify a cryptographic signature for the cryptographically signed data bundle and the signature for the first application;
determine, based on a public key for the application programming interface, whether the cryptographic signature for the cryptographically signed data bundle is verified;
determine, based on a signature for a second application, whether the signature for the first application is verified; and
responsive to determining the cryptographic signature for the cryptographically signed data bundle is verified and the signature for the first application is verified, verify the temporary token.

11. The computing system of claim 10, wherein the one or more processors further execute the instructions to:
responsive to determining that the cryptographic signature for the cryptographically signed data bundle is not verified or the signature for the first application is not verified, deny the request to verify the temporary token.

12. The computing system of claim 10, wherein the first application is executing at a first computing device including a trusted operating system, wherein the second application is executing at a second computing device including an untrusted operating system, and wherein the second application is a trusted application.

13. The computing system of claim 12, wherein the one or more processors receive the request to verify the cryptographic signature for the cryptographically signed data bundle and the signature for the first application from the second computing device, wherein the one or more processors further execute the instructions to:
determine, based on the public key for the application programming interface, the cryptographic signature for the cryptographically signed data bundle is not verified; and
responsive to determining the cryptographic signature for the cryptographically signed data bundle is not verified, deny the request to verify the temporary token.

14. The computing system of claim 12, wherein the one or more processors receive the request to verify the cryptographic signature for the cryptographically signed data bundle and the signature for the first application from the second computing device, wherein the one or more processors further execute the instructions to:
determine, based on the signature for the second application, the signature for the first application is not verified; and
responsive to determining the signature for the first application is not verified, deny the request to verify the temporary token.

15. The computing system of claim 10, wherein the cryptographically signed data bundle further includes the temporary token, and wherein to verify the temporary token, the one or more processors further execute the instructions to:
responsive to determining the cryptographic signature for the cryptographically signed data bundle is verified and the signature for the first application is verified, extract, from the cryptographically signed data bundle, the temporary token;
determine, based on the temporary token, whether the request to verify the cryptographic signature for the cryptographically signed data bundle and the signature for the first application is associated with a trusted computing device; and
responsive to determining that the request to verify the cryptographic signature for the cryptographically signed data bundle and the signature for the first application is associated with a trusted computing device, verify the temporary token.

16. The computing system of claim 15, wherein the one or more processors further execute the instructions to:
responsive to verifying the temporary token, verify a user account.

17. The computing system of claim 15, wherein the temporary token includes a reference to a source computing device including the first application, and wherein to determine whether the request to verify the cryptographic signature for the cryptographically signed data bundle and the signature for the first application is associated with the trusted computing device, the one or more processors further execute the instructions to:
determine, using a cellular communications carrier, and based on the reference, whether the request to verify the cryptographic signature for the cryptographically signed data bundle and the signature for the first application is associated with the source computing device; and
responsive to determining that the request to verify the cryptographic signature for the cryptographically signed data bundle and the signature for the first application is associated with the source computing device, determine, using the cellular communications carrier, that the request to verify the cryptographic signature for the cryptographically signed data bundle and the signature for the first application is associated with the trusted computing device.

18. A non-transitory computer-readable storage medium comprising instructions, that when executed by one or more processors, cause the one or more processors to:
responsive to receiving a request to verify a temporary token, generate, using a trusted framework including an application programming interface, a cryptographically signed data bundle including a signature for a first application;
receive a request to verify a cryptographic signature for the cryptographically signed data bundle and the signature for the first application;
determine, based on a public key for the application programming interface, whether the cryptographic signature for the cryptographically signed data bundle is verified;
determine, based on a signature for a second application, whether the signature for the first application is verified; and
responsive to determining the cryptographic signature for the cryptographically signed data bundle is verified and the signature for the first application is verified, verify the temporary token.

19. The non-transitory computer-readable storage medium of claim 18, wherein the one or more processors further execute the instructions to:
responsive to determining that the cryptographic signature for the cryptographically signed data bundle is not verified or the signature for the first application is not verified, deny the request to verify the temporary token.

20. The non-transitory computer-readable storage medium of claim 18, wherein the first application is executing at a first computing device including a trusted operating system, wherein the second application is executing at a second computing device including an untrusted operating system, and wherein the second application is a trusted application.
